(19) United States
(12) Patent Application Publication
(10) Pub. No.: US 2026/0090946 A1
(43) Pub. Date: Apr. 2, 2026

(54) RAIL-TYPE MASSAGE MECHANISM, MASSAGE CUSHION AND CONTROL METHOD THEREOF

(71) Applicant: Xiamen Annmacare Science & Technology Co., Ltd., XIAMEN (CN)

(72) Inventors: QIANKUN GU, XIAMEN (CN); JINBIN SUN, XIAMEN (CN)

(73) Assignee: Xiamen Annmacare Science & Technology Co., Ltd., XIAMEN (CN)

(21) Appl. No.: 18/988,530

(22) Filed: Dec. 19, 2024

(30) Foreign Application Priority Data
Sep. 29, 2024 (CN) 202422387031.9
Sep. 29, 2024 (CN) 202422389072.1

(51) Int. Cl. A61H 15/00

(52) U.S. Cl. CPC A61H 15/0078; A61H 2201/0134; A61H 2201/1481; A61H 2201/5066

(57) ABSTRACT

A rail-type massage mechanism includes a massage machine core, sliding rails, conductive component, and motor control module arranged outside the massage machine core. The conductive component includes a conductive member and a conductive elastic sheet. The conductive elastic sheet is arranged between two first guide strips of the massage machine core. The conductive member is arranged inside the first guide groove of the sliding rail, the motor control module is electrically connected to the motor inside the massage machine core through the conductive member and the conductive elastic sheet to supply power to the motor. The gears for mechanical transmission and the conductive member for electrical connection are arranged on the same sliding rail.

### CROSS REFERENCE

The present disclosure claims priorities of Chinese Patent Application Nos. 202422389072.1, filed on Sep. 29, 2024, and 202422387031.9, filed on Sep. 29, 2024, the entire contents of which are hereby incorporated by reference in their entirety.

### TECHNICAL FIELD

The present disclosure relates to the field of massage apparatuses, in particular to a rail-type massage mechanism, a massage cushion and a control method thereof.

### BACKGROUND

An existing massage cushion includes a cover assembly and a rail-type massage mechanism disposed inside the cover assembly. The rail-type massage mechanism generally includes a sliding rail and a massage machine core. The massage machine core is slidably disposed on the sliding rail, a motor and a motor control module are installed inside the massage machine core, and the motor control module is connected to an external power supply and a human-computer interaction module (such as a keyboard module) through a flexible wire.

However, the existing massage cushion has the following drawbacks: the flexible wire will move back and forth as the massage machine core slides up and down along the sliding rail, such that the flexible wire is susceptible to defects such as wire damage or even breakage after a long time of use, thereby shortening the service life of the massage mechanism. In addition, in order to reserve space inside the cover assembly for the flexible wire to move back and forth, support frame should be provided in the cover assembly, which in turn increases the volume of the massage cushion and decreases the comfort of use because the massage cushion is hard at the location of the support frame.

Although there are some massage cushion products on the market that use power supply sliding rail mechanisms instead of flexible wires, the following drawbacks still exist: the power supply sliding rail mechanism is arranged separately from the sliding rail of the transmission connection, which causes volume increase of the massage mechanism, thereby increasing the volume of the massage cushion product. What's more, the two conductive members of the power supply sliding rail mechanism may be disconnected for a short period of time during the sliding process due to vibration, wear or other reasons, resulting in a momentary disconnection of the electrical connection, thus it is difficult to maintain the electrical connection consistently. Whereas, the motor control module configured inside the massage machine core requires stable power supply and communication, the momentary disconnection of the electrical connection will cause faults of the massage machine core, and thus making the entire massage mechanism stop running. Therefore, it is necessary to design a novel sliding rail massage mechanism and massage cushion to address the above issues.

### SUMMARY

The objective of the present disclosure is to provide a rail-type massage mechanism, a massage cushion and a control method thereof, which aims to overcome the above-mentioned issues existing in the prior art.

To achieve the above objective, the present disclosure provides the following technical solutions.

A rail-type massage mechanism comprises a massage machine core, two sliding rails, a crossbeam and a motor control module, wherein two ends of a housing of the massage machine core are slidably arranged on the two sliding rails, and the two sliding rails are fixedly connected by the crossbeam; each of the two sliding rails is provided with a rack, a motor and a gear set are installed inside the housing of the massage machine core, and an output shaft of the motor is connected to the rack through the gear set in a transmission manner;

each of the two sliding rails is provided with a set of conductive component, or one of the two sliding rails is provided with two sets of conductive component; the conductive component includes a conductive member and a conductive elastic sheet; the conductive member extending in a length direction of the sliding rail is fixedly arranged on the sliding rail and the conductive member is electrically connected to the motor control module, the conductive elastic sheet is fixedly arranged on the housing of the massage machine core and is electrically connected to the motor, the conductive elastic sheet and the conductive member are in slidable contact, so that the motor control module is electrically connected to the motor.

Each of the sliding rails is provided with a first guide groove extending along a length direction thereof, and the conductive member is fixedly arranged inside the first guide groove; the housing of the massage machine core is provided with two first guide strips arranged in parallel and spaced apart from each other, the conductive elastic sheet is fixedly arranged between the two first guide strips, and the two first guide strips are slidably fitted into the first guide groove.

Furthermore, the conductive elastic sheet is successively provided with a first arc-shaped curved portion, a second arc-shaped curved portion and another first arc-shaped curved portion along a length direction of the sliding rail, and the two first arc-shaped curved portions higher than the second arc-shaped curved portion are configured to butt up against the conductive member.

Furthermore, each of the sliding rails is provided with a second guide groove located between the rack and the conductive member, an extension portion is provided with a second guide strip, and the second guide strip is slidably fitted into the second guide groove; an inner sidewall of the second guide groove is in contact with a sidewall of the second guide strip proximal to the rack and is spaced apart from a sidewall of the second guide strip away from the rack; the inner sidewall of the first guide groove is spaced apart from a sidewall of the first guide strip proximal to the rack and is in contact with a sidewall of another first guide strip away from the rack.

Furthermore, the housing of the massage machine core includes a rear housing, a front housing and side housings, the rear housing and the front housing are engaged with each other, the motor and the gear set are assembled therein, and a massage member is assembled in the front housing; each of a left end and a right end of the rear housing is provided with an extension portion, a first end of the side housings are fixedly connected to left and right ends of the front housing, a second end of the side housings is fixedly connected to the rear housing, the sliding rails are slidably arranged between the extension portions and the side housings respectively, and the conductive elastic sheet is fixedly arranged on at least one of the extension portions.

Furthermore, each of the side housings is provided with a plurality of convex strips at an end surface in contact with the sliding rail.

Furthermore, the first guide strip is provided with a plurality of first avoidance grooves at least on an end surface in contact with the first guide groove.

Furthermore, the second guide strip is provided with a plurality of second avoidance grooves at least on an end surface in contact with the second guide groove.

Furthermore, the first end and the second end of the side housings are respectively provided with a first connection part and a second connection part, the rear housing is provided with a first mounting groove, the first connection part is fixedly fitted into the first mounting groove, the front housing is provided with a second mounting groove, and the second connection part is fixedly fitted into the second mounting groove.

Furthermore, two ends of each of the sliding rails are provided with connection columns, and two ends of the conductive member are provided with connection rings; the connection rings are sleeved on the connection columns, the crossbeam is fixedly connected to the connection columns by fasteners, and the connection rings are clamped between the crossbeam and the sliding rails.

Furthermore, each of the sliding rails is also equipped with a limit switch for limiting a travel distance of the massage machine core.

Furthermore, the massage member is rotatably arranged outside the housing of the massage machine core, and the motor is connected to the massage member in a transmission manner via the gear set.

A massage cushion comprises a cover assembly, wherein a rail-type massage mechanism having any configuration described above is arranged inside the cover assembly.

According to one embodiment, a method for controlling a rail-type massage mechanism having any configuration described above, wherein a control circuit is included, the control circuit comprises a limit switch, the motor control module, the motor and two sets of the conductive component are connected in series, each of an upper end and a lower end of the sliding rails is provided with a limit switch, and the limit switches are electrically connected to the motor control module; the method for controlling the control circuit comprises the following steps:
(a) controlling the motor to rotate forward and the massage machine core to move upward by the motor control module;
(b) controlling the motor to stop running by the motor control module when the massage machine core moves upward and triggers the limit switch, so as to stop the massage machine core; then, controlling the motor to rotate backward by the motor control module so that the massage machine core moves downward;
(c) controlling the motor to stop running by the motor control module when the massage machine core moves downward and triggers the limit switch, so as to stop the massage machine core; then, repeating step (a) and step (b) to allow the massage machine core to move back and forth.

According to another embodiment, a method for controlling the rail-type massage mechanism having any configuration described above, wherein a control circuit is included, the control circuit includes a first microswitch, a second microswitch, the motor control module, the conductive component and the motor; the motor control module, the first microswitch, the motor, the second microswitch and the two sets of conductive components are connected in series; and the first microswitch is connected in parallel with a first diode, the second microswitch is connected in parallel with a second diode, and the anode and cathode of the first diode are opposite to that of the second diode; wherein the first microswitch and the second microswitch are fixedly mounted on an upper end and a lower end of the sliding rails respectively; and the control method includes the following steps:
turning on the circuit when a first output terminal of the motor control module is positive and a second output terminal thereof is negative, as a result the massage machine core moves upward;
turning off the circuit when the massage machine core moves upward and triggers the first microswitch, as a result the massage machine core stops moving and reaches an upper limit;
turning on the circuit when the first output terminal of the motor control module is negative and the second output terminal thereof is positive, as a result the massage machine core moves downward; turning off the circuit when the massage machine core moves upward and triggers the first microswitch, as a result the massage machine core stops moving and reaches the upper limit. Compared with the prior art, the present disclosure has the following advantages.

First, compared to the configuration that the motor control module is arranged inside the massage machine core, according to the present disclosure, the motor control module is arranged outside the massage machine core, and the motor control module is electrically connected to the motor inside the massage machine core through the conductive member and the conductive elastic sheet, therefore there is no need to configure flexible wires. By arranging the motor control module outside the massage machine core, fault of momentary disconnection of the motor control due to unstable slidable connection between the conductive member and the conductive elastic sheet can be avoided. In addition, the gears for mechanical transmission and the conductive members for electrical connection are arranged on the same sliding rail which can greatly reduce the volume of the product compared to the configuration that the gears and the conductive members are arranged separately, thereby making the product smaller and lighter.

Secondly, in the present disclosure, the conductive elastic sheets are arranged between the two first guide strips, and the conductive members are arranged in the first guide groove. The slidable engagement of the two first guide strips and one first guide groove can ensure that the conductive member is consistently aligned with the conductive elastic sheet while sliding with the massage machine core, thus the conductive elastic sheet and the conductive member are well protected, and the electrical connection is more reliable and durable.

Thirdly, in the present disclosure, the conductive elastic sheet is provided with two first arc-shaped curved portions, and a second arc-shaped curved portion is provided between the two first arc-shaped curved portions. The two first arc-shaped curved portions are configured to butt up against the conductive member, so that the conductive elastic sheet has two electrical connection points with the conductive member, thereby improving the stability of the electrical connection therebetween. In order to ensure the stability of the electrical connection, when the second arc-shaped curved portion butts up against the conductive member, the conductive elastic sheet needs to have an elastic deformation, and the second arc-shaped curved portion can well control the influence range of the elastic deformation, thereby reducing the chance that two second arc-shaped curved portions have mutual interference when deformation occurs. In addition, a protrusion is provided between the two first guide strips for butting up against the back of two ends of the second arc-shaped curved portion to support the conductive elastic sheet, thereby further improving the stability and reliability of the electrical connection between the conductive elastic sheet and the conductive member.

Fourthly, the present disclosure is also provided with a second guide groove and a second guide strip in cooperation with each other and are located between the conductive component and the rack. The slidable engagement of the second guide groove and the second guide strip can make the slidable connection between the sliding rails and the massage machine core more stable, which ensures that the rack and the gear set have a consistent transmission connection relationship, thereby avoiding the “slippage” phenomenon. Further, the vibration generated when the rack and the gear set interact with each other can be suppressed and blocked, thereby preventing the vibration from affecting the electrical connection between the conductive elastic sheet and the conductive member.

Fifthly, in the present disclosure, the housing of the massage machine core includes a front housing, a rear housing and side housings. Two ends of the side housings are detachably connected to the front housing and the rear housing, which facilitates the installation and detachment of the massage machine core and the sliding rails, and also facilitates the installation and detachment of the conductive elastic sheet. In addition, the rear housing and the side housings fully cover around the sliding rails, such that the sliding of the massage machine core is more stable.

Sixthly, in the present disclosure, each of the side housings is provided with a plurality of convex strips, the first guide strip is provided with a plurality of first avoidance grooves, and the second guide strip is provided with a plurality of second avoidance grooves. These designs can reduce the contact surface between the sliding rails and the massage machine core and avoid unsmoothed sliding due to the full surface contact.

Seventhly, in the present disclosure, two ends of each of the sliding rails are provided with connection columns, and two ends of the conductive member are provided with connection rings. The connection rings are sleeved on the connection columns to facilitate installation and detachment of the conductive member and keep the conductive member in a taut state, thereby further improving the stability and reliability of the electrical connection between the conductive elastic sheet and the conductive member.

### BRIEF DESCRIPTION OF THE DRAWINGS

FIG. 1 is a three-dimensional schematic diagram of a massage mechanism according to the present disclosure.

FIG. 2 is a first exploded view of a massage machine core according to the present disclosure.

FIG. 3 is a second exploded view of the massage machine core according to the present disclosure.

FIG. 4 is an exploded view showing rails, a crossbeam and a conductive member according to the present disclosure.

FIG. 5 is a three-dimensional schematic diagram of a massage cushion according to the present disclosure.

FIG. 6 is a left view of the massage cushion according to the present disclosure.

FIG. 7 is a control schematic diagram of a motor according to the present disclosure.

FIG. 8 is another control schematic diagram of the motor according to the present disclosure.

### DETAILED DESCRIPTION OF THE EMBODIMENTS

The specific implementation of the present disclosure is described below with reference to the accompanying drawings. In order to fully understand the present disclosure, many details are described below, but for those skilled in the art, the present disclosure may be implemented without these details.

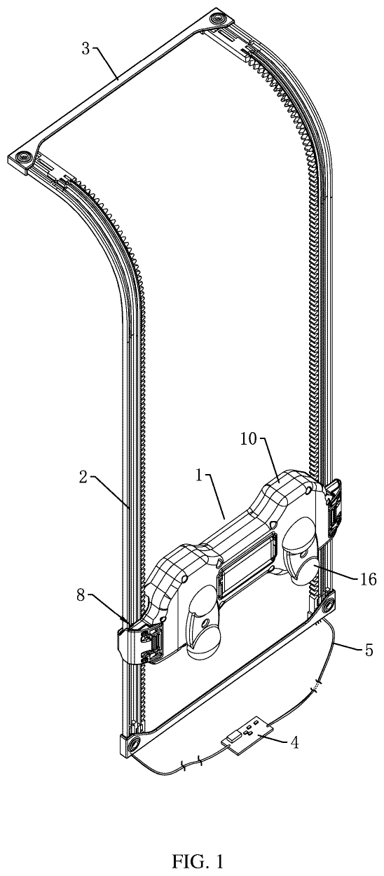

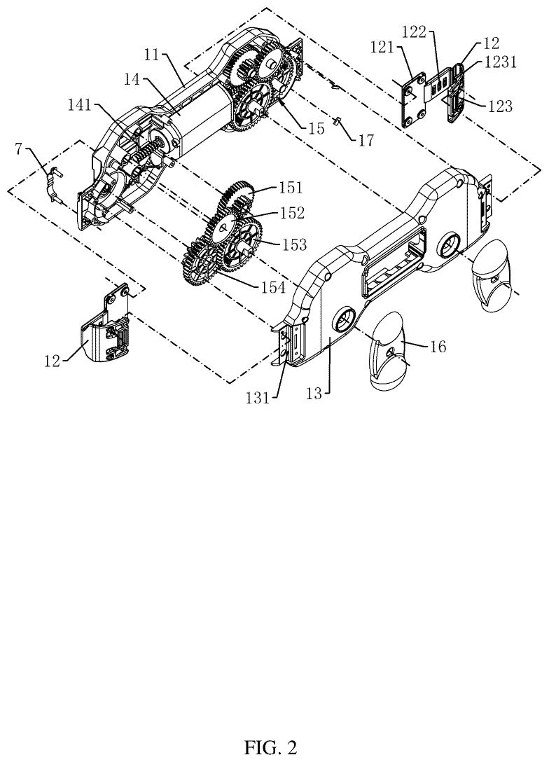

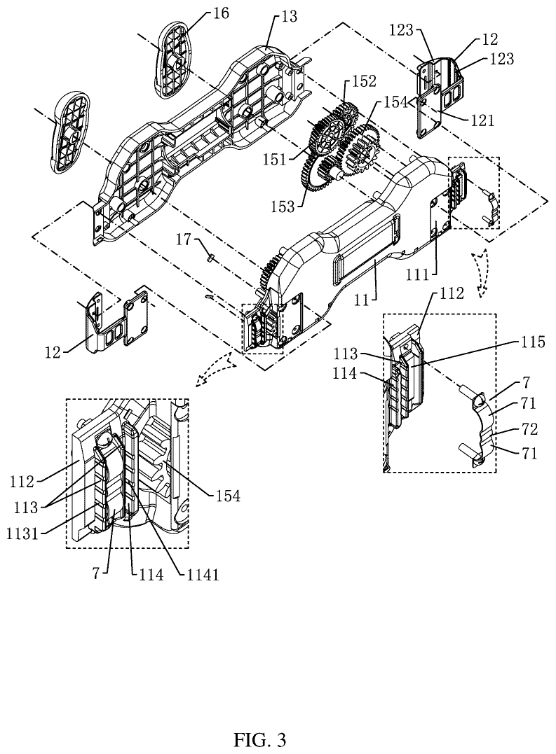

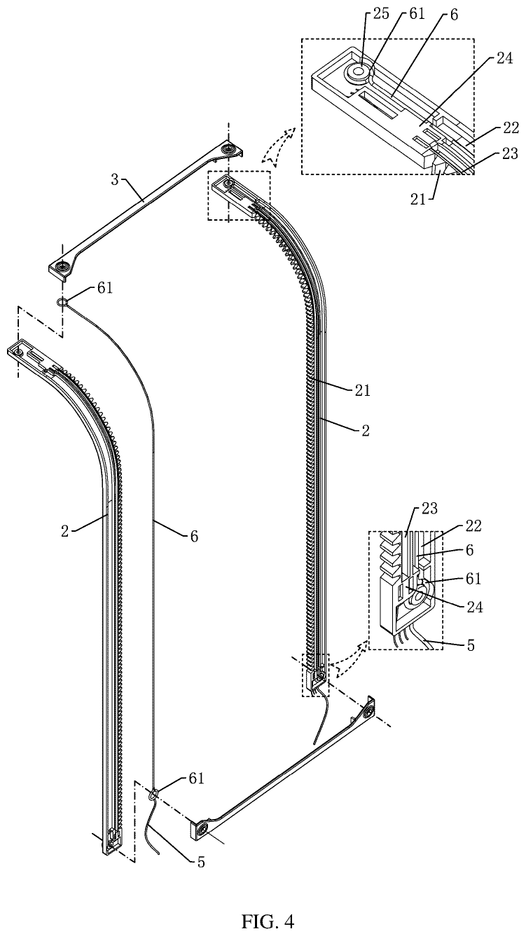

As shown in FIGS. 1-4, a rail-type massage mechanism includes a massage machine core 1, sliding rails 2, a crossbeam 3 and a motor control module 4. Two ends of the housing 10 of the massage machine core 1 are both slidably arranged on the sliding rails 2. The two sliding rails 2 are fixedly connected by the crossbeam 3 so that the two sliding rails 2 remain parallel to each other, which facilitates the sliding of the massage machine core 1. The housing 10 of the massage machine core 1 is externally provided with massage members 16. When the massage machine core 1 slides upward and downward along the sliding rails 2, the massage parts 16 massages the human body.

As shown in FIGS. 1-4, preferably, the sliding rails 2 are flexible members having an elastic deformable performance that can return to its original shape, such as a plastic product. Of course, the sliding rails 2 may also be rigid members, such as an aluminum alloy product.

As shown in FIGS. 1-4, each sliding rail 2 is provided with a rack 21, and a motor 14 and gear sets 15 are installed inside the housing 10 of the massage machine core 1. The motor 14 is a dual-output shaft motor, and the output shafts of the motor 14 are connected to the racks 21 through the gear sets 15, and the motor 14 drives the massage machine core 1 to slide upward and downward along the sliding rails 2.

As shown in FIGS. 1-4, specifically, the housing 10 of the massage machine core 1 includes a rear housing 11 and a front housing 13 which are engaged with each other to form an installation cavity, and the motor 14 and the gear sets 15 are mounted inside the installation cavity.

As shown in FIGS. 1-4, each gear set 15 includes, but not limited to, a first gear 151, a second gear 152, a third gear 153 and a fourth gear 153 that mesh with one another in sequence. Each output shaft of the motor 14 is provided with a worm gear 141 which meshes with the worm wheel of the first gear 151, and the fourth gear 15 meshes with the rack 21.

Referring to FIG. 1 to FIG. 4, preferably, the massage member 16 is rotatably arranged on the front housing 13, and the massage member 16 is driven by the motor 14. Specifically, the massage member 16 is fixedly arranged on the rotating shaft of the third gear 153, and the massage member 16 is driven to rotate by the motor 14 through the gear set 15.

As shown in FIG. 1 to FIG. 4, each of the sliding rails 2 is provided with a set of conductive component 8, and the conductive component 8 includes a conductive member 6 and a conductive elastic sheet 7. The conductive member 6 is fixedly arranged on the sliding rail 2 and extends along the length direction of the sliding rail 2, and the conductive member 6 is electrically connected to the motor control module 4. The conductive elastic sheet 7 is fixed on the housing 10 of the massage machine core 1, and the conductive elastic sheet 7 is electrically connected to the motor 14.

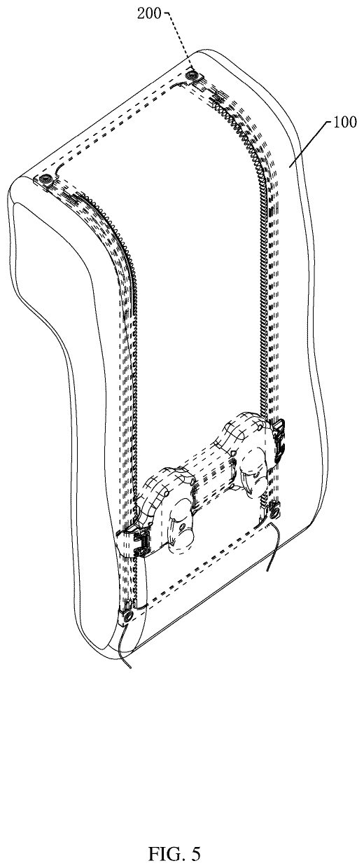

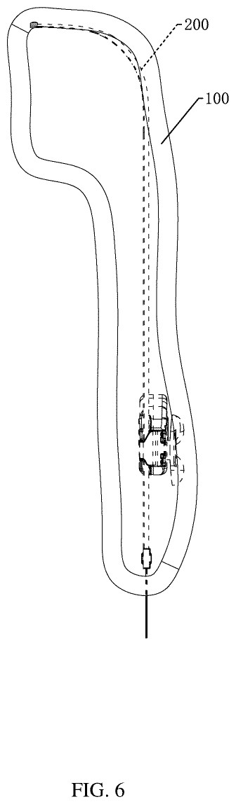

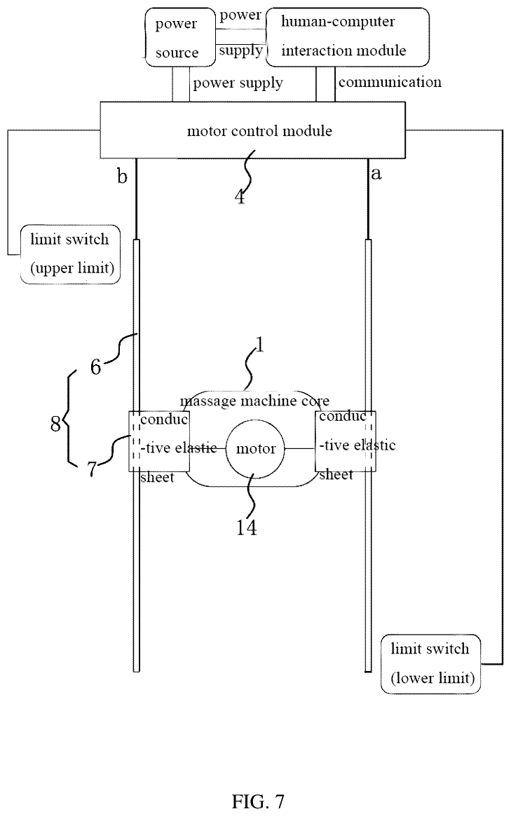

As shown in FIGS. 1-7, the motor control module 4 is arranged outside the massage machine core 1. The motor control module 4 is electrically connected to a power supply and a human-machine interaction module. The human-machine interaction module includes, but is not limited to, a key module configured to input instruction by users and control the massage mechanism. The human-machine interaction module may be integrated in the motor control module 4 or may be separately arranged. After the massage machine core 1 is assembled on the sliding rails 2, the conductive elastic sheets 7 and the conductive members 6 butt up against each other in a slidable manner, so that the motor control module 4 is electrically connected to the motor 14 to supply power to the motor 14.

As shown in FIGS. 1-4, specifically, each of the sliding rails 2 is provided with a first guide groove 22 extending along the length direction thereof, and the conductive member 6 is fixed on the first guide groove 22. The housing 10 of the massage machine core 1 is provided with two first guide strips 113 arranged in parallel and spaced apart from each other, and the massage machine core 1 is fixed with a conductive elastic sheet 7 between the two first guide strips 113. The conductive elastic sheet 7 is electrically connected to the motor 14 through a flexible wire inside the housing 10. After the sliding rails 2 are assembled with the massage machine core 1, the two first guide strips 113 are slidably fitted into the first guide groove 22, and the conductive elastic sheet 7 butts up against the conductive member 6.

As shown in FIGS. 1-4, preferably, the conductive member 6 may be, but is not limited to, a rod-shaped metal member, and two ends of the conductive member 6 are provided with connection rings 61, wherein one of the connection rings 61 is electrically connected with an external wire 5, and the other end of the external wire 5 is electrically connected to the motor control module 4. Two ends of each of the sliding rails 2 are provided with connection columns 25. During assembly, the connection rings 61 are sleeved on the connection columns 25, two ends of the crossbeam 3 are engaged with the end portions of the sliding rails 2, and the crossbeam 3 is fixedly connected to the connection columns 25 by fasteners. The connection ring 61 is clamped between the crossbeam 3 and the sliding rail 2, so that the conductive member 6 is fixedly arranged on the first guide groove 22.

As shown in FIGS. 1-4, specifically, the housing 10 of the massage machine core 1 further includes two side housings 12. Each of the left and right ends of the rear housing 11 is provided with an extension portion 112, and the extension portion 112 is provided with two first guide strips 113 and is equipped with the conductive elastic sheet 7. Each of the left and right ends of the front housing 13 is fixedly connected to one of side housings 12, and the opposite end of the side housing 12 is set around the extension portion 112 and is fixedly connected to the rear housing 11. The side housings 12 are spaced apart from the extension portions 112 to save space for the sliding rails 2 to pass through in a slidable manner. In other words, after the sliding rails 2 are assembled with the massage machine core 1, the sliding rails 2 pass through the space between the extension portions 112 and the side housings 12 in a slidable manner.

As shown in FIGS. 1-4, preferably, each of the side housings 12 generally has a U shape, and a first connection portion 121 and a second connection portion 123 are respectively provided at two ends of the side housing 12. The first connection portion 121 is fixedly fitted into the first mounting groove 111 of the rear housing 11 by screws, and the second connection portion 123 is fixedly fitted into the second mounting groove 131 of the front housing 13 by screws.

As shown in FIGS. 1-4, preferably, two ends of the conductive elastic sheet 7 are fixedly connected to the extension portion 112, and the conductive elastic sheet 7 is successively provided with a first arc-shaped curved portion 71, a second arc-shaped curved portion 71 and another first arc-shaped curved portion 71 along the length direction of the sliding rail 2, the two first arc-shaped curved portions 71 are higher than the second arc-shaped curved portion 71, and the two first arc-shaped curved portions 71 are configured to butt up against the conductive member 6.

Of course, the conductive elastic sheet 7 may also be a second conductive member equipped with a reset spring. Specifically, the second conductive member is movably arranged on the extension portion 112, and the reset spring is configured to drive the second conductive member to move toward the conductive member 6 and to contact the conductive member 6.

The conductive elastic sheet 7 butts up against the conductive member 6 in a slidable manner means that the two components is movable relative to each other while in contact, and the contact may be in the form of surface-to-surface direct contact or rolling contact. The rolling contact may be realized by, but not limited to, rotatably configuring a conductive roller on the conductive elastic sheet 7, and the conductive roller is in contact with the conductive member 6.

As shown in FIGS. 1-4, preferably, the extension portion 112 is provided with a protrusion 115 located between the two first guide strips 113, two ends of the conductive elastic sheet 7 are fixedly connected to the extension portion 112, and the back sides of the two ends of the second arc-shaped curved portion 71 butt up against the protrusion 115.

As shown in FIGS. 1-4, preferably, each of the sliding rails 2 is further provided with a second guide groove 23 located between the rack 21 and the conductive component 8, and the extension portion 112 of the housing 10 is further provided with a second guide strip 114. After the massage machine core 1 and the sliding rails 2 are assembled, the second guide strip 114 is slidably fitted into the second guide groove 23. In other words, each of the sliding rails 2 is provided with a second guide groove 23 located between the rack 21 and the first guide groove 22, and the extension portion 112 of the rear housing 11 is provided with a second guide strip 114 located between the first guide strip 113 and the fourth gear 154.

Referring to FIGS. 1-4, an inner sidewall of the second guide groove 23 is in contact with a sidewall of the second guide strip 114 proximal to the rack 21, and the inner sidewall of the second guide groove 23 is spaced apart from the other sidewall of the second guide strip 114 away from the rack 21. At the same time, the inner sidewall of the first guide groove 22 is spaced apart from the sidewall of the first guide strip 113 proximal to the rack 21, and the inner sidewall of the first guide groove 22 is in contact with the sidewall of the other first guide strip 113 away from the rack 21. In other words, the second guide strip 114 and the first guide strip 113 limit the sliding rail 2 from the left and right directions respectively to prevent deflection of the massage machine core 1; the above separation can reduce the sliding contact area between the first guide strip 113, the second guide strip 114 and the sliding rail 2, making the sliding smoother and preventing jamming.

As shown in FIGS. 1-4, preferably, the first guide strip 113 is at least provided with a plurality of first avoidance grooves 1131 on an end surface in contact with the first guide groove 22. The second guide strip 114 is at least provided with a plurality of second avoidance grooves 1141 on an end surface in contact with the second guide groove 23. An end surface of the side housing 12 in contact with the sliding rail 2 is provided with a plurality of convex strips 123.

Of course, in addition to the configuration that each of the two sliding rails 2 is provided with a set of conductive component 8, alternatively, one of the two sliding rails 2 may be provided with two sets of conductive component 8 to supply power to the motor 14. In other words, one of the extension portions 112 is provided with two conductive elastic sheets 7 arranged side by side, and the corresponding sliding rail 2 is provided with conductive members 6 arranged side by side.

As shown in FIGS. 1-4, the sliding rail 2 is also equipped with a limit switch for limiting the travel distance of the massage machine core 1. Specifically, the upper and lower ends of the sliding rail 2 are both equipped with limit switches for defining the upper limit and the lower limit of the massage machine core 1. Specifically, an upper end and a lower end of one of the sliding rails 2 are boh provided with mounting portions 24 for mounting the limit switches, and the two limit switches are arranged at the upper and lower ends of the same sliding rail 2. Of course, the two limit switches may also be arranged on two sliding rails 2 respectively with one being arranged on the upper end and one on the lower end.

As shown in FIGS. 1-4, preferably, the limit switch is a Hall switch. Accordingly, two magnet blocks 17 for triggering the Hall switches are installed inside the housing 10 of the massage machine core 1. Specifically, two magnet blocks 17 are installed at one end of the rear housing 11 with one being arranged on an upper side and one on a lower side for triggering the upper and lower Hall switches, respectively. Of course, the limit switches may also be a touch rod type microswitch.

As shown in FIGS. 1-6, the present disclosure further discloses a massage cushion, including a cover assembly 100, wherein the cover assembly 100 is internally provided with a rail-type massage mechanism 200 having any structure described above. The cover assembly 100 includes, but not limited to, wear-resistant cloth (or wear-resistant gauze), filler (such as sponge, latex, etc.) and stitched artificial leather. The specific structure may be referred to the cover assembly of existing massage products, which will not be repeated here. Preferably, the rail-type massage mechanism 200 is placed inside the cover assembly 100 and is removable. The left and right inner walls and the upper and lower inner walls of the cover assembly 100 butt up against the rail-type massage mechanism 200, so that the rail-type massage mechanism 200 and the cover assembly 100 cannot move relative to each other.

As shown in FIGS. 1-7, the present disclosure also discloses a method for controlling the above-mentioned rail-type massage mechanism, including a control circuit. The motor control module 4, the motor 14 and the two sets of conductive components 8 of the control circuit are connected in series to form a power supply circuit for the motor 14. In addition, the limit switches at the upper and lower ends of the sliding rail 2 are electrically connected to the motor control module 4 for providing enable signals to control the motor 14 by the motor control module 4, which is independent of the power supply circuit for the motor 14. The control method includes the following steps:
(a) supplying power to the motor 14 by the motor control module 4, so that the motor 14 rotates forward and the massage machine core 1 moves upward along the sliding rails 2;
(b) cutting off the power supply to the motor 14 by the motor control module 4 when the massage machine core 1 moves upward and triggers the limit switch, as as to stop the massage machine core 1; then, supplying power to the motor 14 by the motor control module 4 to make the motor 14 rotate backward so that the massage machine core 1 moves downward along the sliding rail 2;
(c) cutting off the power supply to the motor 14 by the motor control module 4 when the massage machine core 1 moves downward to the lower limit and triggers the limit switch, so as to stop the massage machine core 1; then, repeating step (a) and step (b) to allow the massage machine core 1 to move back and forth between the upper limit and the lower limit;
(d) controlling the motor control module 4 to cut off the power supply to the motor 14 by the human-machine interaction module, so as to make the massage machine core 1 stop at any position between the upper limit and lower limit.

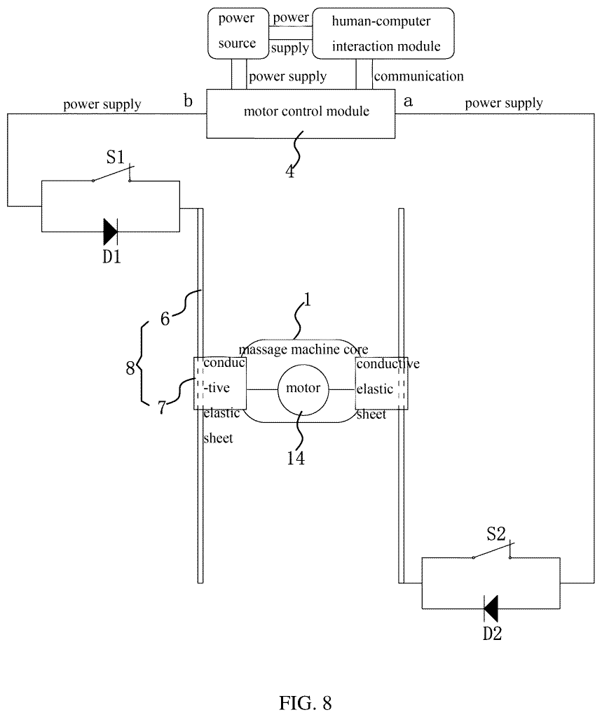

As shown in FIGS. 1-6 and FIG. 8, the present disclosure also discloses another method for controlling the rail-type massage mechanism having any structure described above, including a control circuit. The control circuit mainly includes a first microswitch S1, a second microswitch S2, a motor control module 4, a conductive component 8 and a motor 14. The motor control module 4, the first microswitch S1, the motor 14, the second microswitch S2 and the two sets of conductive components 8 are connected in series. In addition, the first microswitch S1 is connected in parallel with a first diode D1, the second microswitch S2 is connected in parallel with a second diode D2, and the cathode and anode of the first diode D1 are arranged opposite to that of the second diode D2. Among them, the first microswitch S1 is fixedly assembled on the upper end of the sliding rail 2, and the second microswitch S2 is fixedly assembled at the lower end of the sliding rail 2, and they are both normally closed switches. The conductive member 6 of the conductive component 8 is fixedly assembled on the sliding rails 2, and the conductive elastic sheets 7 of the motor 14 and the conductive component 8 are both fixedly assembled on the massage machine core 1, and the conductive elastic sheet 7 is in contact with the conductive member 6 in a slidable manner. Of course, the motor control module 4 is electrically connected to a power source and a human-machine interaction module.

As shown in FIGS. 1-4, the method for controlling the above-mentioned rail-type massage mechanism generally includes the following steps:

turning on the circuit when a first output terminal a of the motor control module 4 is positive and a second output terminal b thereof is negative, as a result the massage machine core 1 moves upward; turning off the circuit when the massage machine core 1 moves upward and triggers the first microswitch S1, as a result the massage machine core 1 stops moving and reaches an upper limit;

turning on the circuit when the first output terminal a of the motor control module 4 is negative and the second output terminal b thereof is positive, as a result the massage machine core 1 moves downward; turning off the circuit when the massage machine core 1 moves upward and triggers the first microswitch S1, as a result the massage machine core 1 stops moving and reaches the upper limit.

More specifically, the control method is as follows.

(1) When the first output terminal a of the motor control module 4 is positive and the second output terminal b thereof is negative, the current flows through the second microswitch S2, the second diode D2 and the first microswitch S1, and the circuit is turned on; accordingly, the massage machine core 1 moves upward.

When the massage machine core 1 moves upward and triggers the first microswitch S1, the first microswitch S1 is disconnected, the first diode D1 is turned off, and the circuit is disconnected. Accordingly, the massage machine core 1 stops moving and reaches the upper limit.

(2) In the case of step (1), when the first output terminal a of the motor control module 4 is negative and the second output terminal b is positive, the current flows through the first diode D1 and the second microswitch S2, and the circuit is turned on. Accordingly, the massage machine core 1 moves downward.

When the massage machine core 1 leaves the upper limit, proceed to step (3).

(3) In the case of step (2), when the first output terminal a of the motor control module 4 is negative and the second output terminal b is positive, the current flows through the first microswitch S1, the first diode D1 and the second microswitch S2, and the circuit is turned on. Accordingly, the massage machine core 1 moves downward.

When the massage machine core 1 moves downward and triggers the second microswitch S2, the second microswitch S2 is disconnected, and the second diode D2 is turned off, and the circuit is disconnected. Accordingly, the massage machine core 1 stops moving and reaches the lower limit.

(4) In the case of step (3), when the first output terminal a of the motor control module 4 is positive and the second output terminal b is negative, the current flows through the second diode D2 and the first microswitch S1, and the circuit is turned on. At this time, the massage machine core 1 moves upward.

When the massage machine core 1 leaves the lower limit, proceed to step (1).

The above description merely involves some specific implementation of the present disclosure, and the design concept of the present disclosure is not limited thereto. Any non-substantial changes to the present disclosure based on this concept shall be deemed as an infringement of the protection scope of the present disclosure.

What is claimed is:

1. A rail-type massage mechanism, comprising a massage machine core, sliding rails, a crossbeam and a motor control module; the sliding rails are slidably arranged at two ends of a housing of the massage machine core; the two sliding rails are fixedly connected via the crossbeam; the sliding rail is provided with a rack; the housing of the massage machine core is internally equipped with a motor and a gear set; an output shaft of the motor is connected to the rack in a transmission manner via the gear set; characterized in that: each of the two sliding rails is provided with a set of conductive component, or one of the sliding rails is provided with two sets of conductive component;
wherein the conductive component comprises a conductive member and a conductive elastic sheet; the conductive member is fixedly arranged on the sliding rail extending along a length direction thereof, and the conductive member is electrically connected to the motor control module; the housing of the massage machine core is fixedly provided with the conductive elastic sheet, and the conductive elastic sheet is electrically connected to the motor; the conductive elastic sheet and the conductive member butt up against each other in a slidable manner, so that the motor control module is electrically connected to the motor.

2. The rail-type massage mechanism according to claim 1, characterized in that: each of the sliding rails is provided with a first guide groove extending along the length direction of the sliding rail, and the conductive member is fixedly arranged on the first guide groove; the housing of the massage machine core is provided with two first guide strips arranged in parallel and spaced apart from each other, the conductive elastic sheet is fixedly arranged between the two first guide strips; and the two first guide strips are fitted into the first guide groove in a slidable manner.

3. The rail-type massage mechanism according to claim 1, characterized in that: the conductive elastic sheet is provided with a first arc-shaped curved portion, a second arc-shaped curved portion, and another first arc-shaped curved portion in sequence along the length direction of the sliding rail; the two first arc-shaped curved portions are higher than the second arc-shaped curved portion for butting up against the conductive member.

4. The rail-type massage mechanism according to claim 2, characterized in that: each of the sliding rails is further provided with a second guide groove located between the rack and the conductive component; the extension portion is provided with a second guide strip, and the second guide strip is fitted into the second guide groove in a slidable manner; an inner sidewall of the second guide groove is in contact with a sidewall of the second guide strip proximal to the rack, and is spaced apart from another sidewall of the second guide strip away from the rack; an inner sidewall of the first guide groove is spaced apart from a sidewall of the first guide strip proximal to the rack, and is in contact with a sidewall of another first guide strip away from the rack.

5. The rail-type massage mechanism according to claim 1, characterized in that: the housing of the massage machine core comprises a rear housing, a front housing and side housings, the rear housing is engaged with the front housing; each of a left end and a right end of the rear housing is provided with an extension portion, a left end and a right end of the front housing are fixedly connected to a first end of the side housings, a second end of the side housings is fixedly connected to the rear housing, and the sliding rail passes through a space between the extension portion and the side housings in a slidable manner; at least one extension portion is fixedly provided with the conductive elastic sheet.

6. The rail-type massage mechanism according to claim 1, characterized in that: each of the first guide strips is at least provided with a plurality of first avoidance grooves on an end surface in contact with the first guide groove.

7. The rail-type massage mechanism according to claim 1, characterized in that: two ends of each of the sliding rails are provided with connection columns, and two ends of the conductive member are provided with connection rings; the connection rings are sleeved on the connection columns, the crossbeam is fixedly connected to the connection columns by fasteners, and the connection rings are clamped between the crossbeam and the sliding rails.

8. A massage cushion, comprising a cover assembly, characterized in that the cover assembly is internally provided with a rail-type massage mechanism having a structure as described in claim 1.

9. A method for controlling a rail-type massage mechanism according to claim 1, characterized in that: a control circuit is included, wherein the control circuit comprises a limit switch, the motor control module, the motor and two sets of the conductive components, wherein the motor control module, the motor and the two sets of conductive components are connected in series, an upper end and a lower end of the sliding rails are both provided with the limit switch, and the limit switches are electrically connected to the motor control module; a method for controlling the control circuit comprises:
(a) controlling the motor to rotate forward and the massage machine core to move upward by the motor control module;
(b) controlling the motor to stop running by the motor control module when the massage machine core moves upward and triggers the limit switch, so as to stop the massage machine core;
then, controlling the motor to rotate backward by the motor control module so that the massage machine core moves downward;
(c) controlling the motor to stop running by the motor control module when the massage machine core moves downward and triggers the limit switch, so as to stop the massage machine core; then, repeating step (a) and step (b) to allow the massage machine core to move back and forth.

10. A method for controlling a rail-type massage mechanism according to claim 1, characterized in that: a control circuit is included, wherein the control circuit comprises a first microswitch, a second microswitch, the motor control module, the conductive component and the motor; wherein the motor control module, the first microswitch, the motor, the second microswitch and the two sets of conductive components are connected in series; and the first microswitch is connected in parallel with a first diode, the second microswitch is connected in parallel with a second diode, and a cathode and a anode of the first diode are opposite to that of the second diode; wherein the first microswitch and the second microswitch are fixedly mounted on an upper end and a lower end of the sliding rails (2), respectively; the method comprises:
turning on the circuit when a first output terminal of the motor control module is positive and a second output terminal thereof is negative, as a result the massage machine core moves upward; turning off the circuit when the massage machine core moves upward and triggers the first microswitch, as a result the massage machine core stops moving and reaches an upper limit;
turning on the circuit when the first output terminal of the motor control module is negative and the second output terminal thereof is positive, as a result the massage machine core moves downward; turning off the circuit when the massage machine core moves upward and triggers the first microswitch, as a result the massage machine core stops moving and reaches the upper limit.
